(19) United States
(12) Patent Application Publication
(10) Pub. No.: US 2004/0147141 A1
(43) Pub. Date: Jul. 29, 2004

(54) Casing structure for electronic apparatus

(75) Inventor: I-Jung Yang, Taipei (TW)

Correspondence Address: BACON & THOMAS, PLLC, 625 SLATERS LANE, FOURTH FLOOR, ALEXANDRIA, VA, 22314

(73) Assignee: Delta Electronics, Inc., Taipei (TW)

(21) Appl. No.: 10/431,468

(22) Filed: May 8, 2003

(30) Foreign Application Priority Data
Jan. 24, 2003 (TW) 092201317

(51) Int. Cl. H01R 12/00

(52) U.S. Cl. 439/75

(57) ABSTRACT

A casing structure for an electronic apparatus is disclosed. The casing structure includes a main body to be placed on a surface of an object, and at least one sucker disposed on at least one side of the main body, thereby attaching the electronic apparatus on the surface to prevent the electronic apparatus from moving relative to the surface of the object.

### FIELD OF THE INVENTION

The present invention relates to a casing structure for an electronic apparatus, and more particularly to a casing structure for an adapter used in a portable computer or an information appliance.

### BACKGROUND OF THE INVENTION

Portable electric appliance or information appliance, such as portable computer, Personal Digital Assistant (PDA) or digital audio recorder, has become more and more popular in our daily life. In order to make the portable information appliance available for use momentarily, a user needs to carry a power adapter for supplying the required power to the portable information appliance or a charger for charging the battery. Therefore, the power adapter or charger has become an essential accessory to maintain the electric power of the portable information appliance anytime. However, when the power adapter is employed to cooperate with a portable information appliance, the user always pulls and drags the power cord connected between the portable information appliance and the power adapter by accident, so as to cause the portable information appliance and/or the power adapter to fall from the table to the ground. Particularly, the internal circuit structure of the portable information appliance and the power adapter are delicate and can't endure collisions. The frequent collisions or falls would increase the breakdown rate of the portable information appliance or the power adapter, and even influence the use life of the portable information appliance.

Giving an example for illustration. Please refer to FIG. 1, which illustrates a portable computer in use according to the prior art. As shown in FIG. 1, when a user uses a portable computer 11, the portable computer 11 is put on a surface 12 of a table and a power adapter 13 is employed to electrically connect the portable computer 11 with the utility power source. However in the dim surroundings, more particularly at a meeting with a dim light, the user usually pulls and drags the power cord 131 of the power adapter 13 by accident, and more seriously the portable computer 11 and/or the power adapter 13 is pulled and falls from the table to the ground. When the above-mentioned situations happen, the internal circuit structure of the portable computer 11 and/or the power adapter 13 may be damaged and broken down. For example, the liquid crystal display (LCD) of the portable computer 11 may crack and fail to display anymore, and the most important hard disk may be out of order and a lot of data may be lost accordingly. When the above accident happens, the meeting should be suspended and it will cause great damage to the user.

Actually, that kind of accident happens around us frequently. Therefore, it needs to provide a casing structure of an electronic apparatus for allowing the electronic apparatus to be tightly attached to a surface of an object and preventing the electronic apparatus from falling to the ground. It also needs to provide a casing structure of an electronic apparatus, which can be assembled easily and efficiently, and can rectify those drawbacks of the prior art and solve the above encountered problems.

### SUMMARY OF THE INVENTION

It is an object of the present invention to provide a casing structure of an electronic apparatus for allowing the electronic apparatus to be tightly attached to a surface of an object and preventing the electronic apparatus from moving relative to the surface of the object.

In accordance with one aspect of the present invention, the casing structure for the electronic apparatus includes a main body to be placed on a surface of an object, and at least one sucker disposed on at least one side of the main body for attaching the electronic apparatus on the surface of the object, thereby preventing the electronic apparatus from moving relative to the surface of the object.

Preferably, the electronic apparatus is an adapter or a power supply. The sucker has a specific height to form a neck portion for winding a power cord of the electronic apparatus around. In addition, the main body further comprises at least one fastening device for fastening the sucker on the side of the main body. Preferably, the fastening device is an engaging hole or a trench.

In accordance with another aspect of the present invention, the casing structure for an electronic apparatus includes a main body to be placed on a surface of an object and having a frictional surface in contact with the surface of the object, thereby increasing friction between the main body of the electronic apparatus and the surface of the object to prevent the electronic apparatus from moving relative to the surface of the object.

Preferably, the frictional surface further includes a rubber pad with a wave surface. More preferably, the frictional surface further includes a meshed spot layer or a magnet.

In accordance with an additional aspect of the present invention, the casing structure for an electronic apparatus includes a main body to be place on a surface of an object, and at least one clamping device disposed on the main body for clamping an clamped object disposed on the surface of the object and/or increasing the friction between the main body and the surface of the object, thereby preventing the electronic apparatus from moving relative to the surface of the object.

Preferably, the clamping device further includes a rubber pad or a cross stripe for increasing the friction between the electronic apparatus and the surface of the object when the electronic apparatus is placed on the surface of the object.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view showing a portable computer in use according to prior art;

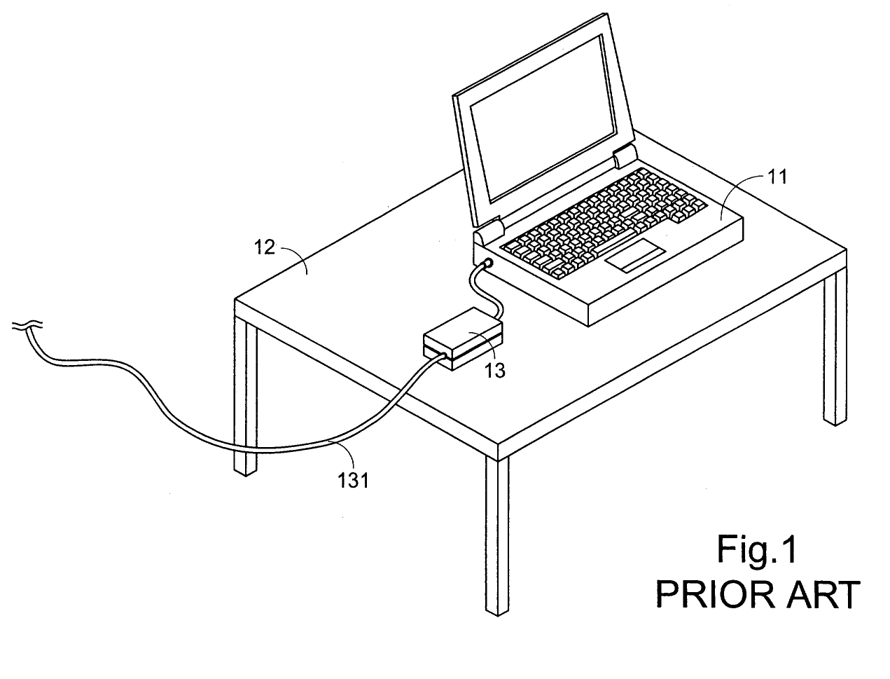

FIG. 2 is a schematic view showing the casing structure of the electronic apparatus according to a preferred embodiment of the present invention;

FIG. 3 is a schematic view showing the electronic apparatus of FIG. 2 in use;

FIG. 4 is a schematic view showing the casing structure of the electronic apparatus according to another preferred embodiment of the present invention;

FIG. 5 is a schematic view showing the electronic apparatus being charged according to the preferred embodiment of FIG. 4; and

FIG. 6 is a schematic view showing the casing structure of the electronic apparatus according to a further preferred embodiment of the present invention.

### DETAILED DESCRIPTION OF THE PREFERRED EMBODIMENT

The present invention discloses a casing structure for an electronic apparatus such as power adapter. The present invention will now be described more specifically with reference to the following embodiments. It is to be noted that the following description of the preferred embodiment of this invention is presented herein for purpose of illustration and description only; it is not intended to be exhaustive or to be limited to the precise form disclosed. Any electronic apparatus capable of utilizing the same technology such as charger, power supply, mobile phone, personal digital assistance (PDA), digital audio recorder or other small-scale information products are incorporating herein for reference.

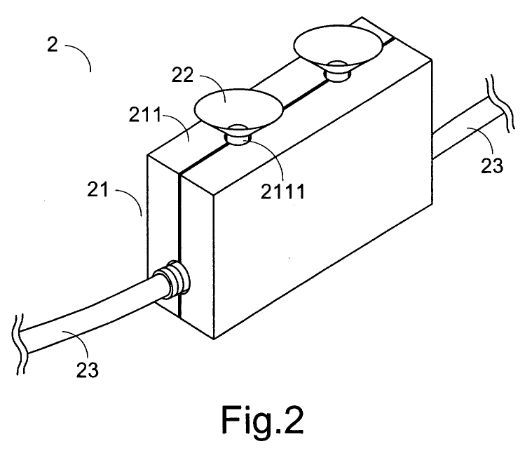

Please refer to FIG. 2, which shows a casing structure of an electronic apparatus according to a preferred embodiment of the present invention. In this embodiment, the electronic apparatus is preferably a power adapter. As shown in FIG. 2, the casing structure of the electronic apparatus 2 includes a main body 21 and at least one sucker 22, wherein the sucker 22 is disposed on one side 211 of the main body 21 by engaging the sucker 22 with a fastening device 2111, such as an engaging hole or trench (not shown), on the side 211 of the main body 21. Preferably, two suckers 22 are disposed on the side 211 of the main body 21. Certainly, these suckers 22 can be selectively disposed on any one of the six faces of the main body 21. Moreover, the electronic apparatus 2 further includes two power cords 23, one of which is electrically connected with an information appliance (not shown) and the other of which is electrically connected with the utility power source. The electronic apparatus 2 is generally employed for rectifying and converting the external AC power into the DC power, so as to supply the required power to an information appliance, such as a portable computer, or charge the charging battery.

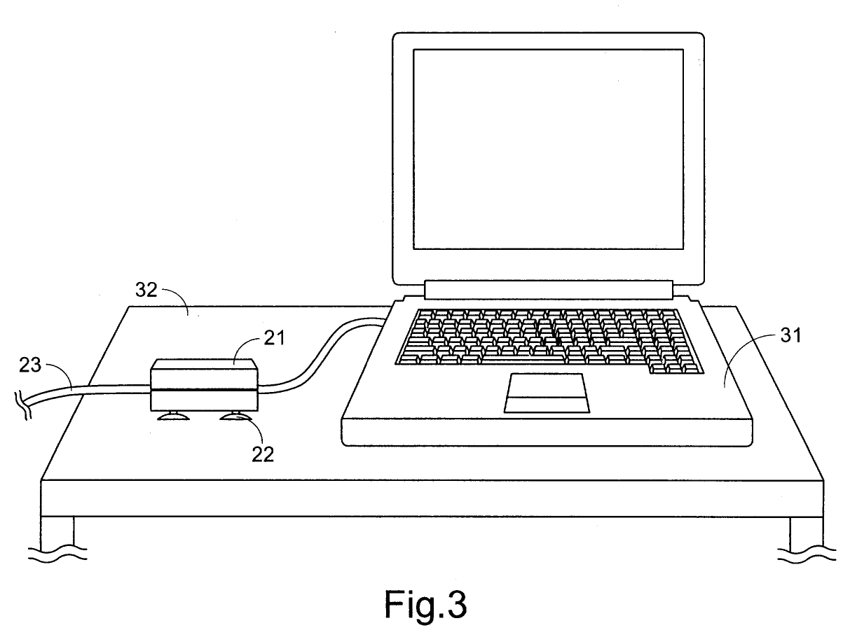

Please refer to FIG. 3, which shows the electronic apparatus of FIG. 2 in use. When the electronic apparatus 2 is employed, the main body 21 of the electronic apparatus 2 is placed on a surface 32 of an object such as a table or a desk, and the side 211 disposing the sucker 22 thereon faces the surface 32 of the object. While the sucker 22 is in contact with the surface 32 of the object and pressed against the surface 32 of the object, the flexible cup of the sucker 22 become deformed with consequential expulsion of air from within the flexible cup and gripping the surface 32 of the object by the flexible cup. Thereby, a friction between the surface 32 of the object and the side 211 of the electronic apparatus 2 is increased to prevent the main body 21 of the electronic apparatus 2 from moving relative to the surface 32 of the object. In other words, when the electronic apparatus 2 is in use and any power cord 23 of the electronic apparatus 2 is pulled by accident, the additional friction between the sucker 22 and the surface 32 of the object will prevent the electronic apparatus 2 from moving relative to the surface 32 of the object. Thus, the portable computer 31 connected to the electronic apparatus 2 won't fall to the ground while the power cord 23 is pulled by accident. Furthermore, when the sucker 22 is attached to the surface 32 of the object, a gap will be formed between the electronic apparatus 2 and the surface 32 of the object due to the specific height of the sucker 22. Therefore there will be enough space for the electronic apparatus 2 to dissipate the heat generated from the electronic apparatus 2 by means of air convection. So the surface temperature of the electronic apparatus 2 will be decreased, and the power converting efficiency of the electronic apparatus 2 will be promoted. Moreover, the specific height of the sucker 22 can form a neck portion for facilitating the user to wind the power cord 23 of the electronic apparatus 2 around the sucker 22. Accordingly, the electronic apparatus 2 of the present invention has an advantage of receiving the power wire easily.

In addition to attach the sucker 22 on the surface 32 of an object as shown in FIG. 3, the sucker 22 can also be attached on a vertical wall (not shown) for achieving the same effect and increasing the convenience in utility.

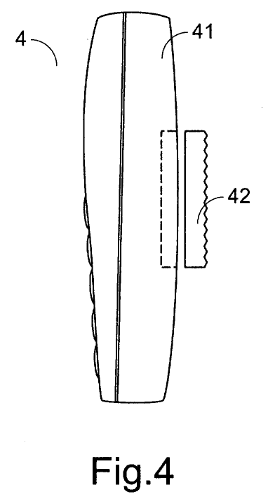

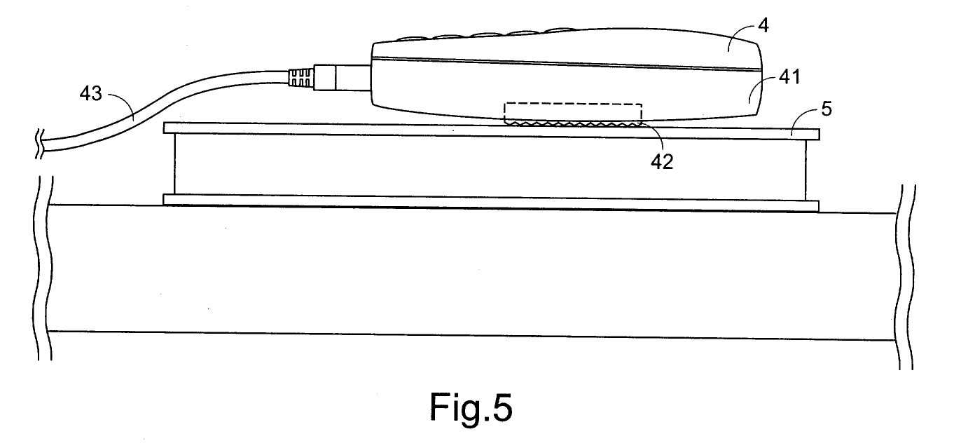

Please refer to FIG. 4, which illustrates the casing structure of the electronic apparatus according to another preferred embodiment of the present invention. In this embodiment, the electronic apparatus 4 is preferably a mobile phone. As shown in FIG. 4, the electronic apparatus 4 includes a frictional surface 41 to be placed on a surface of an object. The frictional surface 41 of the electronic apparatus 4 has a rubber pad 42 with a wave surface. When the electronic apparatus 4 is placed on the surface 5 of the object for allowing the electronic apparatus 2 to be charged, it will be electrically connected with the utility power source via a power cord 43 as shown in FIG. 5. Meanwhile the friction between the frictional surface 41 of the electronic apparatus 4 and the surface 5 of the object will be increased via the rubber pad 42 with a wave surface. For example, when the electronic apparatus 4 is placed on a cover page of a book, the electronic apparatus 4 won't move relative to the cover page of the book due to the friction formed between the frictional surface 41 of the electronic apparatus 4 and the cover page of the book. Even though the power cord 43 of the electronic apparatus 4 is pulled and tugged during the period of charging by accident, the rubber pad 42 with a wave surface will prevent the electronic apparatus 4 from moving relative to the cover page of the book or falling to the ground to cause the electron apparatus 4 out of order.

In the above-mentioned embodiment, the frictional surface 41 of the electronic apparatus 4 could further include a meshed spot layer or a magnet (not shown) for increasing the friction between the electronic apparatus 4 and the surface 5 of the object. Furthermore, the surface 5 of the object is not limited to a smooth one. A rough surface is also suitable for use.

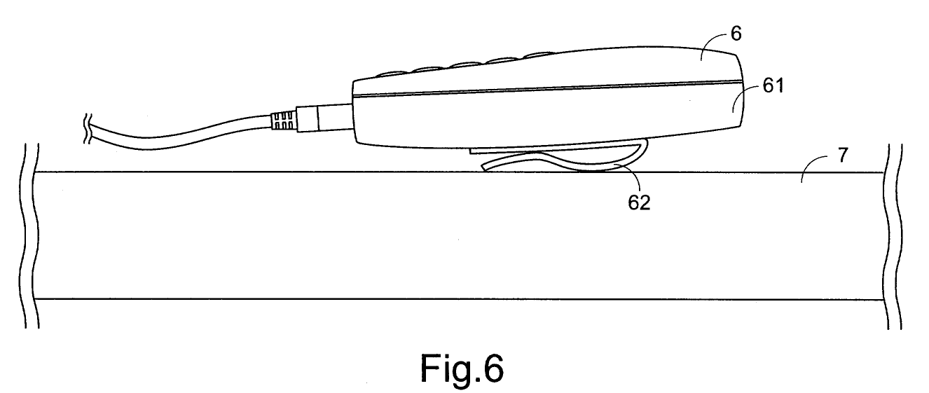

Please further refer to FIG. 6, which shows the casing structure of the electronic apparatus according to a further preferred embodiment of the present invention. In this embodiment, the electronic apparatus 6 is preferably a mobile phone. As shown in FIG. 6, the electronic apparatus 6 is placed on a surface 7 of an object and includes at least one clamping device 62 disposed on the main body 61 of the electronic apparatus 6. Preferably, the clamping device 62 includes a rubber pad with a wave surface or a cross strip (not shown). When there is a clamped object (not shown) disposed on the surface 7 of the object, the clamped device 62 of the electronic apparatus 6 can clamp the clamped object to prevent the electronic apparatus 6 from moving relative to the surface 7 of the object. On the other hand, when there is no clamped object disposed on the surface 7 of the object and the electronic apparatus 6 is placed on the surface 7 of the object directly for allowing the electronic apparatus 6 to be charged, it will be electrically connected with the utility power source via a power cord as shown in FIG. 6. Meanwhile the friction between the clamping device 62 of the electronic apparatus 6 and the surface 7 of the object will be increased via the rubber pad with the wave surface or the cross strip for preventing the electronic apparatus 6 from moving relative to the surface 7 of the object.

In conclusion, the present invention provides a casing structure of an electronic apparatus, which increases the friction between the electronic apparatus and the contacting surface of an object. When the electronic apparatus is placed on the surface of the object, the electronic apparatus is exempted from moving or slipping relative to the surface of the object, thereby avoiding breakdown of the electronic apparatus and increasing the use life of the electronic apparatus by means of increasing the friction between the electronic apparatus and the surface of the object. Accordingly, the casing structure of the present invention not only prevents the electronic apparatus from collision or falling to the ground, but also provides an additional function of receiving the power cord. Furthermore, the casing structure of the electronic apparatus disclosed in the above-mentioned embodiments can increase the effect of dissipating the heat generated from the electronic apparatus. In addition, the casing structure of the present invention is manufactured easily and efficiently, but it won't cost a lot. Accordingly, the present invention possesses many outstanding characteristics, effectively improves upon the drawbacks associated with the prior art in practice and application, produces practical and reliable products, bears novelty, and adds to economical utility value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A casing structure for an electronic apparatus, comprising:
a main body to be placed on a surface of an object; and
at least one sucker disposed on at least one side of said main body for attaching said electronic apparatus on said surface of said object,
thereby preventing said electronic apparatus from moving relative to said surface of said object.

2. The casing structure according to claim 1 wherein said electronic apparatus is an adapter or a power supply.

3. The casing structure according to claim 1 wherein said sucker has a specific height to form a neck portion for winding a power cord of said electronic apparatus around.

4. The casing structure according to claim 1 wherein said main body further comprises at least one fastening device for fastening said sucker on said side of said main body.

5. The casing structure according to claim 4 wherein said fastening device is an engaging hole.

6. The casing structure according to claim 4 wherein said fastening device is a trench.

7. A casing structure for an electronic apparatus, comprising:
a main body to be placed on a surface of an object and having a frictional surface in contact with said surface of said object, thereby increasing friction between said main body of said electronic apparatus and said surface of said object to prevent said electronic apparatus from moving relative to said surface of said object.

8. The casing structure according to claim 7 wherein said frictional surface further comprises a rubber pad.

9. The casing structure according to claim 8 wherein said rubber pad comprises a wave surface.

10. The casing structure according to claim 7 wherein said frictional surface further comprises a meshed spot layer.

11. The casing structure according to claim 7 wherein said frictional surface further comprises a magnet.

12. A casing structure for an electronic apparatus, comprising:
a main body to be place on a surface of an object; and
at least one clamping device disposed on said main body for clamping an clamped object disposed on said surface of said object and increasing the friction between said main body and said surface of said object, thereby preventing said electronic apparatus from moving relative to said surface of said object.

13. The casing structure according to claim 12 wherein said clamping device further comprises a rubber pad or a cross stripe for increasing the friction between said electronic apparatus and said surface of said object when said electronic apparatus is placed on said surface of said object.
